(19) United States
(12) Patent Application Publication
(10) Pub. No.: US 2026/0309510 A1
(43) Pub. Date: Oct. 8, 2026

(54) METHOD, USER TERMINAL AND SERVER FOR DISPLAYING OBJECT INCLUDING PLURALITY OF PLACE INFORMATION IN MAPPING SERVICE

(71) Applicant: KAKAO CORP., Jeju-si (KR)

(72) Inventors: Su Yeon JUNG, Seongnam-si (KR); Seo Ha YU, Seongnam-si (KR)

(21) Appl. No.: 19/453,879

(22) Filed: Jan. 20, 2026

(30) Foreign Application Priority Data
Apr. 2, 2025 (KR) 10-2025-0042606

(51) Int. Cl. G01C 21/36

(52) U.S. Cl. CPC G01C 21/3679; G01C 21/367; G01C 21/3673

(57) ABSTRACT

Proposed is a method performed by a user terminal for displaying an object including a plurality of place information in a map service. The method may include displaying a map interface included in the map service and configured to display first location information. The method may also include transmitting a query related to the map service and the first location information to the server. The method may further include displaying an object including a plurality of place information related to at least one of the query and the first location information.

### CROSS-REFERENCE TO RELATED APPLICATION

This application claims priority to and the benefit of Korean Patent Application No. 10-2025-0042606 filed on Apr. 2, 2025, the disclosure of which is incorporated herein by reference in its entirety.

### BACKGROUND

### Technical Field

The present disclosure relates to a method performed by a user terminal for displaying an object including a plurality of place information in a map service.

### Description of Related Technology

Recent advancements in smartphones and map services have enabled a user to easily search and store information on specific locations. A user may store places of interest, such as restaurants, cafes, and tourist attractions, within a map application and later retrieve the stored places when needed. Based on the stored location information, the user may generate and utilize a personal list of places. Some map services are configured to allow a user to share stored location information with friends or specific groups.

### SUMMARY

One aspect is to share a plurality of locations stored in a map service in the form of a single object, thereby allowing the stored locations to be shared in a more flexible manner beyond personal use.

Another aspect is to provide an object including location attribute information of each object and including one or more places associated with a user's current location or with a location designated by the user in a map service.

Another aspect is a method performed by a user terminal for displaying an object including a plurality of place information in a map service. The method includes: displaying a map interface included in the map service and configured to display first location information; transmitting a query related to the map service and the first location information to the server; and displaying an object including a plurality of place information related to at least one of the query and the first location information.

Displaying the object may include displaying the object in response to an interaction with an interface configured to display the object.

Displaying the object may include displaying the object together with result information of the query.

The first location information may be at least one of a current location information of the user terminal and location information selected by the user in the map interface.

The method may further include: displaying a reference setting interface for setting a reference for the first location information; and receiving a reference for the first location information through the reference setting interface.

The reference setting interface may include information on an option related to the reference, and the option may include an option for a current location of the user terminal and an option for a location selected by the user.

The first location information may be determined based on a scale of the map service.

The plurality of place information may be a plurality of place information stored by a specific user account in the map service.

The object may be displayed only when search of the object is permitted by a user account that shares the object.

Another aspect is a user terminal for displaying an object including a plurality of place information in a map service. The user terminal includes a memory storing instructions and a processor configured to execute the instructions to: based on first location information, display a map interface included in the map service; transmit a query related to the map service and the first location information to a server; and display an object including a plurality of place information related to at least one of the query and the first location information.

Another aspect is a method performed by a server for providing an object including a plurality of place information through a map service. The method includes: receiving a query and first location information from a user terminal through a map service; and providing, to the user terminal, an object including a plurality of place information related to at least one of the query and the first location information.

The method may further include determining whether the query includes second location information. In providing the object, the object may include a plurality of place information related to the second location information when the query includes the second location information, and the object may include a plurality of place information related to the first location information when the query does not include the second location information.

The object may include location attribute information, and the first and second location information may be associated with the location attribute information.

The method may further include determining the location attribute information based on a plurality of place information included in the object.

The method may further include receiving information on the object from a specific user account.

The method may include receiving the location attribute information of the object from the specific user account.

Providing the object may include: determining whether a predetermined relationship between a user account of the user terminal and the specific user account is satisfied; and providing the object when the predetermined relationship is satisfied.

In yet another aspect, a server for providing an object including a plurality of place information through a map service. The server includes a memory storing instructions and a processor configured to execute the instructions to: receive a query and first location information from a user terminal through a map service; and provide, to the user terminal, an object including a plurality of place information related to at least one of the query and the first location information.

### BRIEF DESCRIPTION OF THE DRAWINGS

FIG. 1 is a diagram illustrating an example of a network environment according to one embodiment of the present disclosure.

FIG. 2 is a flowchart illustrating a method performed by a user terminal of the present disclosure for displaying an object including a plurality of place information.

FIG. 3 illustrates a screen in which a specific user terminal shares an object including a plurality of place information according to one embodiment of the present disclosure.

FIG. 4 schematically illustrates a screen in which a server identifies location attribute information of an object according to one embodiment of the present disclosure.

FIGS. 5 to 10 illustrate screens in which a user terminal displays an object including a plurality of place information according to one embodiment of the present disclosure.

FIG. 11 is a flowchart illustrating a method performed by a server of the present disclosure for providing an object including a plurality of place information.

### DETAILED DESCRIPTION

Some location storage and sharing methods are primarily used for personal purposes or in a limited manner. That is, in most existing map applications, even when a specific location is stored, the stored information is used only for personal reference, or, in some services, is limited to sharing with friends or a specific group. As a result, there is a limitation in sharing and utilizing stored location information across a broader range of users.

To address this limitation, there has been a demand for technological solutions that enable more open and flexible sharing of stored location information and that enhance collaboration and recommendation functions. Through such solutions, a user may more easily share location information and receive recommendations for useful places from other users.

Hereinafter, embodiments disclosed in this specification will be described in detail with reference to the accompanying drawings. Regardless of the drawing numbers, identical or similar components are given the same reference numbers and redundant descriptions thereof will be omitted. In addition, when describing the embodiments disclosed in this specification, if it is determined that a detailed description of a related known technology may obscure the gist of the embodiments disclosed in this specification, the detailed description is omitted.

Terms including ordinal numbers, such as first, second, etc., may be used to describe various components, but the components are not limited by the terms. The terms are used solely to distinguish one component from another.

Singular expressions include plural expressions unless the context clearly indicates otherwise.

In this application, each step described may be performed regardless of the listed order, except in cases where a special causal relationship requires that the steps be performed in the listed order.

In this application, terms such as “include” or “have” are intended to specify the presence of a feature, number, step, operation, component, part or combination thereof described in the specification, but should be understood not to exclude in advance the possibility of the presence or addition of one or more other features, numbers, steps, operations, components, parts or combinations thereof.

Hereinafter, the present disclosure will be described with reference to the accompanying drawings.

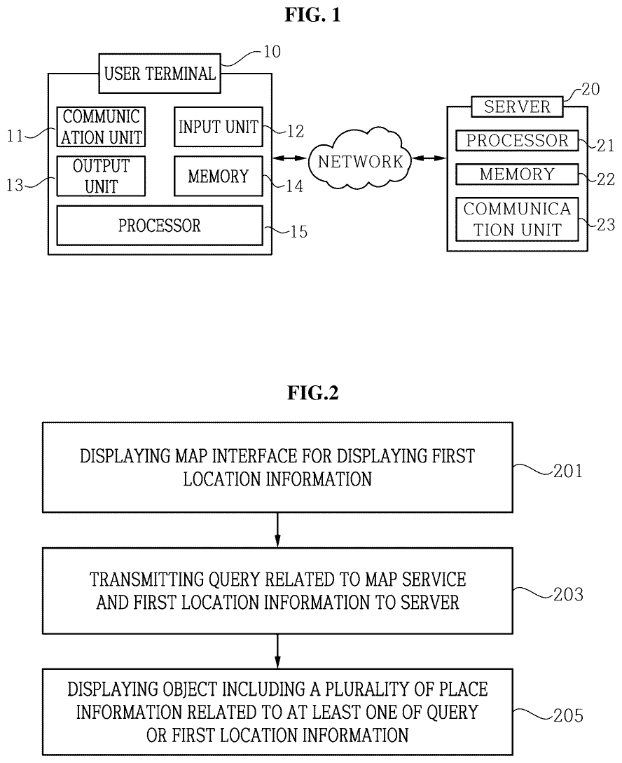

FIG. 1 is a diagram illustrating an example of a network environment according to one embodiment of the present disclosure.

A network environment according to one embodiment of the present disclosure, as illustrated in FIG. 1, may include a user terminal 10 and a server 20. The user terminal 10 may be at least one user terminal connected to the server 20 via a network.

The network is not limited to a particular communication method, and may include communication using various networks, such as a mobile communication network, a wired Internet, a wireless Internet, or a broadcasting network, as well as short-range wireless communication.

The user terminal 10 may be a terminal used by logging in with a user account registered in a map service provided by the server 20.

The user terminal 10 may include a communication unit 11, an input unit 12, an output unit 13, a memory 14, and a processor 15.

The communication unit 11 may communicate with the server 20 or other terminals in a wired or wireless manner.

The input unit 12 may receive various information through a user's operations and input actions. The input unit 12 may include a touch screen module, a keyboard, a mouse, a button, a camera, a stylus, a microphone, or the like.

The user terminal 10 may receive the user's interaction through the input unit 12. An interaction refers to inputting information reflecting the user's selection or intention into the user terminal 10 through manipulation of the input unit. For example, an interaction may include touching a touchscreen, clicking a mouse, typing on a keyboard, receiving sound input from a microphone, capturing an image using a camera, recognizing a movement via a motion sensor, and the like.

The output unit 13 may output various information. The output unit 13 may be a display device, a speaker, a vibration generating device, a tactile generating device, or the like.. In some cases, the output unit 13 may be a device (for example, a Bluetooth earphone) that is connected to the user terminal 10 via wired or wireless communication (for example, short-range wireless communication such as Bluetooth) to receive and output signals.

The memory 14 functions as a storage medium and may store application programs executed by the user terminal 10, and data and instructions for operation of the user terminal 10. The memory 14 may be implemented using various storage devices, such as ROM, RAM, a flash memory, or a hard disk, or may be implemented in the form of web storage.

In one embodiment, a map service or map application configured to share an object including a plurality of place information may be stored in the memory 14.

The processor 15 may control overall operations of the communication unit 11, the input unit 12, the output unit 13, and the memory 14 to execute a map service configured to share objects including a plurality of place information.

In the present disclosure, the user terminal 10 may display a map interface configured to display first location information. Here, the map interface may be an interface included in the map service. The user terminal 10 may transmit a query and first location information related to the map service to the server 20, and display an object including a plurality of place information related to at least one of the query and the first location information.

The map service refers to a service for receiving a query from a user and displaying an object including a plurality of place information. The map service may include a map interface configured to display a specific place or location and an input interface (e.g., an input field) for entering a query. The map service may display a current location of a user or location information selected by the user in the map interface. The user terminal 10 may display a specific location on the map interface and receive a query from the user. In this case, the user terminal 10 may display, through the map service, an object including result information of a query and a plurality of place information.

The first location information may be specific location information displayed by the user terminal 10 on the map interface. Specifically, the first location information may be displayed in various ways. For example, the first location information may be current location information (e.g., current GPS location information) of the user terminal 10 at a time when the user terminal 10 executes the map service. In another example, the first location information may be location information selected by the user on the map interface of the user terminal 10. In yet another example, the first location information may be location information that is displayed by the user terminal 10 in response to a specific query received from the user.

The plurality of place information may be information on a plurality of places provided by the map service. The plurality of place information may be place information stored by a specific user in the map service. Specifically, the specific user may store places of interest (e.g., restaurants, cafes, and tourist attractions) in the map service. The plurality of place information may be stored in a specific object.

An object refers to a storage space or group including a plurality of place information. For example, the object may be a collection of place information including a plurality of place information. The object may include a plurality of place information and location attribute information, each associated with a location. The plurality of places included in the object may be place information stored by the user terminal 10 or a specific user terminal in the map service.

For example, an object may be a collection of place information that includes a plurality of places that a user has registered as places of interest (or favorite places) in the map service. That is, the user terminal 10 may store a plurality of place information in an object in the map service and share the object with a specific user.

The user terminal 100 storing an object may share (or allow search of) the object so that a specific user can search and display the object. In this case, when the user terminal 10 obtains an interaction related to displaying a specific object in the map service, the user terminal 10 may display the specific object.

An interaction related to displaying an object may be an interaction with an interface configured to display the object. For example, the interaction may include performing an interaction with an “object” interface in the map service. In contrast, the interaction may include entering a query related to a place search in a map service.

The server 20 may be implemented as a computer device or a plurality of computer devices configured to provide commands, codes, files, content, and services. The server 20 may transmit and receive information through communication with the user terminal 10 via a network.

The server 20 may include a processor 21, a memory 22, and a communication unit 23.

The processor 21 may control overall operations of the memory 22 and the communication unit 23 to provide an object including a plurality of place information through the map service.

The memory 22 functions as a storage medium and may store application programs executed by the server 20, and data and instructions for operation of the server 20, and instructions. In one embodiment, the memory 22 may store location attribute information of an object.

The memory 22 may be implemented using various storage devices, such as ROM, RAM, a flash drive, or a hard drive, or may be implemented in the form of web storage.

The communication unit 23 may communicate with the user terminal 10 via a network in a wired or wireless manner.

In the present disclosure, the server 20 may receive a query and first location information from a user terminal 10 through a map service, and may provide, to the user terminal 10, an object including a plurality of place information related to at least one of the query and the first location information.

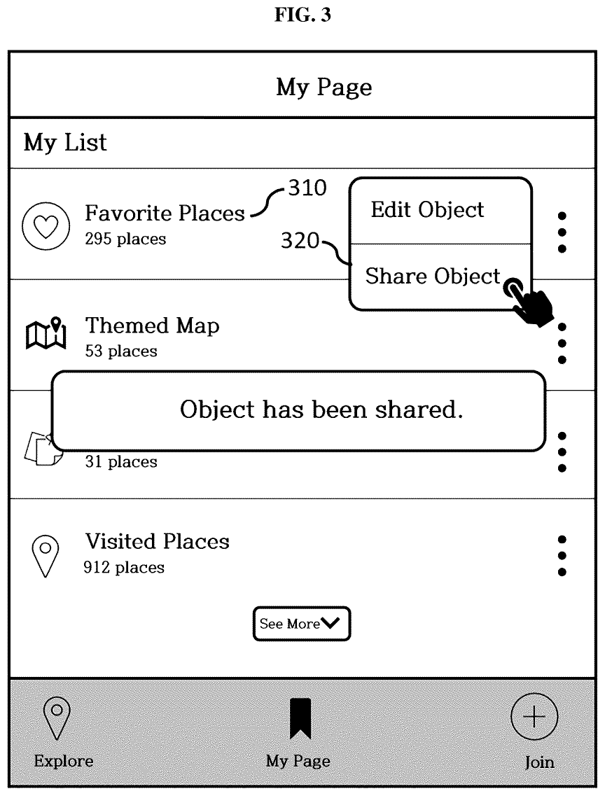

Hereinafter, with reference to FIGS. 2 to 8, one embodiment of a method performed by the user terminal 10 for displaying an object including a plurality of place information will be described.

FIG. 2 is a flowchart illustrating a method performed by the user terminal 10 for displaying an object including a plurality of place information.

In operation 201, the user terminal 10 displays a map interface associated with first location information.

A map service may include various interfaces. Specifically, the map service may include a map interface configured to display a specific place or location, an input interface (e.g., an input field) for receiving a user query, and an interface configured to display result information of the query. When the user terminal 10 executes the map service, the first location information may be displayed through the map interface.

The first location information may be displayed in various ways.

As an example, the first location information may be location information based on current GPS coordinates of the user terminal 10. Specifically, when the user terminal 10 executes the map service, a current location of the user terminal 10 may be displayed on the map interface based on the GPS information.

As another example, the first location information may be location information selected by a user on the map interface of the user terminal 10. Specifically, a user may arbitrarily select a specific location on the map interface. In this case, the first location information may be a location displayed on the map interface rather than the current location of the user.

As yet another example, the first location information may be a location displayed in response to a query input in the map service. Specifically, the user may enter a query into the input field of the map service. The user terminal 10 may display, on the map interface, a location corresponding to the query. In this case, the first location information may be a location displayed on the map interface in response to the query, rather than the user's current location.

The user terminal 10 may set a reference for the first location information. Specifically, the user terminal 10 may display a reference setting interface for setting a reference for the first location information. The reference setting interface may include information on a selectable option. Here, the selectable option may include at least one of an option for a current location of the user terminal 10 and an option for a location selected by a user. The user terminal 10 may receive a reference for the first location information from the user through an interface that allows selection of the reference.

When the user terminal 10 sets the reference for the first location information to be a current location, the first location information may be determined to be the current location even if a different location is displayed on the map interface.

However, when the user terminal 10 sets the reference for the first location information to be a location selected by a user, other location information displayed on the map interface by the user terminal 10 may be determined as the first location information.

The first location information may be determined based on a scale of the map service. Specifically, as the user terminal 10 changes the scale of the map in the map service, the first location information may be changed. For example, when the user terminal 10 displays Pangyo-dong on the map interface with a relatively large map scale, the first location information may be determined to be Pangyo-dong. However, when the user terminal 10 reduces the map scale at the same location, the first location information may be determined or changed to be Bundang-gu.

In some cases, when a query includes location information (e.g., second location information), the server 20 may perform operations 203 to 205 based on the second location information instead of the first location information. Detailed descriptions related thereto will be provided in more detail in each step.

In operation 203, the user terminal 10 transmits a query related to the map service and first location information to the server 20.

Before performing operation 203, the server 20 may receive information on an object including a plurality of place information from a specific user terminal. Specifically, the specific user account may store information on a specific place in the map service. The specific user account may store information on the specific place in the object. Thereafter, the specific user account may provide the object to the server 20. As the specific user account provides the object to the server 20, the user terminal 10 may be able to search and display the object provided by the specific user account. That is, providing the object to the server 20 by the specific user account may allow other user terminals to search the object.

Even if the specific user account stores the object including the plurality of place information, when the object is not provided to the server 20, the object may be displayed only on a terminal of the specific user account and other user terminals may be unable to search the object.

Conversely, the specific user account may set a disclosure status of the object to be public or private. Specifically, even when the specific user account provides the object to the server 20, if permission to search the object is not granted and the object is set to a private state, other user terminals may be unable to search the object.

An object may include location attribute information. The location attribute information may be an example of tag information. The location attribute information may be a name of a region or a name of a specific commercial district or tourist attraction. For example, the location attribute information may be a name of a region such as Sinsa-dong. In contrast, the location attribute information may be a name of a specific commercial district such as Garosu-gil.

The location attribute information may be determined based on a plurality of place information included in the object. The location attribute information may be information related to the plurality of place information included in the object. The location attribute information may be determined in various ways.

As an example, the location attribute information may be determined based on the plurality of place information included in the object. For example, if all (or a predetermined percentage or more) of the plurality of places included in the object are located in Sinsa-dong, the object may include location attribute information such as Sinsa-dong. In contrast, if the plurality of places included in the object are located in Seoul (i.e., in any area of Seoul, not a specific area of Seoul), the object may include location attribute information such as Seoul. In this case, the location attribute information may be generated by the server 20.

As another example, the location attribute information may be determined based on a name of the object. Specifically, when the server 20 receives information on an object from a specific user terminal, the server 20 may also receive information on the name of the object. In this case, the server 20 may determine location attribute information based on the name of the object. For example, if the name of the object is “Pangyo Restaurants for Office Worker Group Dining,” the object may include location attribute information such as Pangyo-dong. In this case, the location attribute information may be generated by the server 20.

As yet another example, the location attribute information may be determined by a specific user terminal that shares an object. Specifically, the server 20 may receive the location attribute information along with information on the object from the specific user terminal. In this case, the location attribute information may be determined based on the location attribute information received from the specific user terminal. For example, when the server 20 receives information on an object from a specific user terminal, the server 20 may also receive location attribute information such as Gangnam-gu. In some cases, the location attribute information may include both location attribute information received from the specific user terminal and location attribute information generated by the server 20.

In some cases, if the information received by the server 20 from a specific user terminal is tag information other than location attribute information, such as good restaurant or group dining recommendation, the location attribute information may be determined by another method described above.

The server 20 may provide an object in response to receiving, from a user terminal 10, an interaction related to displaying the object. The interaction may be performed in various ways.

As an example, an interaction related to displaying an object may be an interaction with a specific interface. Specifically, the map service may include an object interface (or object tab) including a plurality of objects. The interaction may be interacting with an object interface.

As another example, an interaction related to displaying an object may be a user entering a query related to searching of a place in the map service. Specifically, the map service may include an input field into which the user can enter a query. The interaction may be receiving a specific query in the input field.

In operation 205, the user terminal 10 displays an object including a plurality of place information related to at least one of the query and the first location information.

When the user terminal 10 obtains, from the user, an interaction related to displaying the object, the user terminal 10 may display the object including a plurality of place information.

The user terminal 10 may receive a query related to the map service. When the user terminal 10 receives the query, the user terminal 10 may display the object together with result information of the query.

The object may be associated with at least one of the query and the first location information. Specifically, when a query includes location information (e.g., second location information), the user terminal 10 may display an object including a plurality of place information related to the second location information. However, if the query does not include location information, the user terminal 10 may display an object including a plurality of place information related to the first location information.

The user terminal 10 may display an object that satisfies a display condition. Here, the display condition may include various conditions. For example, the display condition may be set such that the object is public or searchable. Specifically, the object may be displayed only when another user terminal providing information on the object has permitted disclosure or search of the object.

The display condition may be related to location attribute information of the object. Specifically, the display condition may be set such that the location attribute information is identical to the first location information or the second location information. For example, the display condition may be set such that the location attribute information of the object is Pangyo-dong and the first location information is also Pangyo-dong.

In addition, the display condition may be set such that the location attribute information is related to the first location information or the second location information. For example, a predetermined condition may be satisfied even when location attribute information includes a plurality of location attribute information such as Seoul, Bundang-gu, and Pangyo-dong, and the first location information or the second location information is Pangyo-dong.

In some cases, the object may be displayed only when a predetermined relationship between a user account of the user terminal 10 and a specific user account is satisfied. Here, the predetermined relationship may include a friend relationship, a subscription relationship, a follow or following relationship, a relationship in which both parties register each other's phone numbers, or a relationship in which one party stores the other party's phone number.

In addition, the display condition may be related to the number of a plurality of places included in the object. Specifically, the display condition may be set such that the object includes a plurality of places equal to or greater than a predetermined number (e.g., 30).

In addition, the display condition may be related to a type of place information included in the object. Specifically, the type of place information may include a shareable type and a non-shareable type. Whether the place information is of a shareable type may be preset by an operator

For example, place information of the shareable type may include restaurants, travel destinations, cultural places, art-related places, sports or leisure sports-related places, or the like. Place information of the non-shareable type may include medical, health, finance, insurance, law enforcement agencies, or the like.

The display condition may be set such that all of the plurality of places included in the object are of the shareable type, or such that a predetermined percentage (e.g., 80% or more) of the plurality of places are of the shareable type.

In addition, the display condition may be related to a point in time at which the object is shared. Specifically, the display condition may be set such that the object is displayed only for a predetermined period after the object is shared. For example, the display condition may be set such that the object is displayed only for three years after the object is shared.

The user terminal 10 may display an object in response to an interaction with an interface configured to display the object. Specifically, the user terminal 10 may display first location information, such as a GPS-based current location of the user terminal 10 or a location selected by a user. Thereafter, the user terminal 10 may obtain, from the user, an interaction with the interface configured to display the object. In this case, the user terminal 10 may display an object related to the first location information.

When the server 20 receives, through the map service, a request from the user terminal 10 to provide an object including a plurality of place information, the server 20 may determine whether a predetermined relationship between the user account of the user terminal 10 and a specific user account is satisfied. Thereafter, the server 20 may provide only an object shared by the user account that satisfies a predetermined relationship.

In contrast, when the server 20 receives a request from the user terminal 10 to provide an object, the server 20 may provide any object that satisfies the display conditions. Thereafter, when the server 20 receives, from the user terminal 10, a request to view an object that does not satisfy the predetermined relationship, the server 20 may provide guidance information to guide a user to first establish a relationship, such as a subscription or follow, with respect to the object.

A request to provide an object may be inputting tag information of the object, location attribute information of the object, and description information related to the object. When a specific object is a reported object, the server 20 may suspend provision of the specific object. In addition, when at least one item of the plurality of place information included in an object corresponds to a reported place, the server 20 may suspend provision of the object.

When a report for an object is withdrawn or a report status of the object is cleared, the server 20 may provide the object again.

Even when a specific account is reported, the server 20 may suspend provision of any object shared by the specific account.

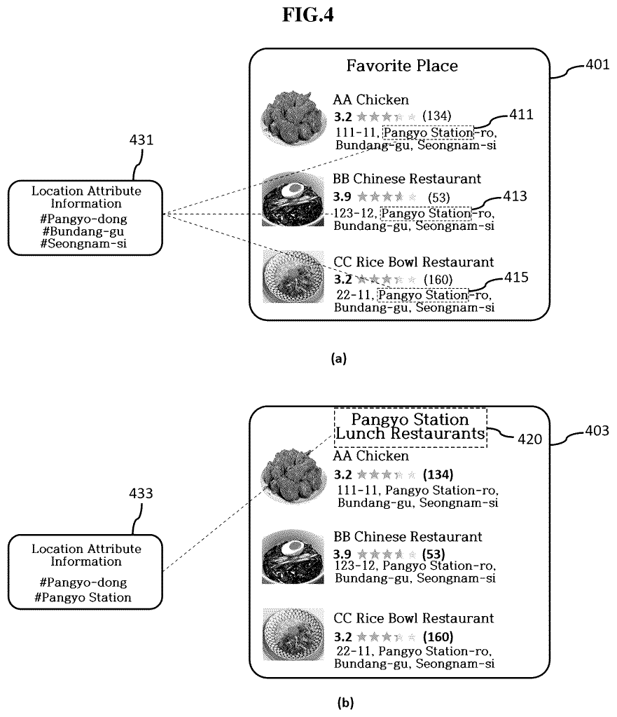

FIG. 3 illustrates a screen in which a specific user terminal shares an object including a plurality of place information according to one embodiment of the present disclosure.

Referring to FIG. 3, a specific user terminal may share an object. Specifically, the specific user terminal may save places of interest, such as restaurants and cafes, in the map service. As an example, a plurality of places stored by the specific user terminal may be stored on a page such as Favorite Places 310.

In some cases, when a specific place is registered with the map service, the place may be included in a specific object from the time of registration. For example, when “AA Chinese Restaurant” (location: Pangyo-dong) is registered with the map service, the place may be included from the outset in an object such as “Pangyo-dong Chinese Restaurants,” based on location information of “AA Chinese Restaurant” and category information such as “Chinese restaurant.”

The specific user terminal may share a plurality of places saved in Favorite Places 310 with other users. Specifically, the specific user terminal may share the plurality of saved places through an interface 320 for sharing Favorite Places 310.

When the specific user terminal shares Favorite Places 310, a plurality of place information included in Favorite Places 310 may be shared as an object. That is, Favorite Places 310 may be shared through a single object.

As Favorite Places 310 is shared, an object corresponding to Favorite Places 310 may become a target of search. Specifically, only when the specific user terminal provides Favorite Places 310 to the server 20, an object including the Favorite Places 310 may be displayed in response to a query from another user terminal.

The specific user terminal may set a disclosure status of an object to be public or private. Specifically, even when the specific user terminal provides Favorite Places 310 to the server 20, if a disclosure status of an object including the Favorite Places 310 is set to private, other user terminals may be unable to search the object including the Favorite Places 310. That is, only when the disclosure status of the object is set to public, other user terminals may be unable to search the object including the Favorite Places 310.

When the server 20 receives a request to share an object from the specific user terminal, the server 20 may provide the object in response to a request for provision of the object from the user terminal 10 or another user terminal.

Although not shown in the drawing, the specific user terminal may provide location attribute information and the name of the object when sharing the object.

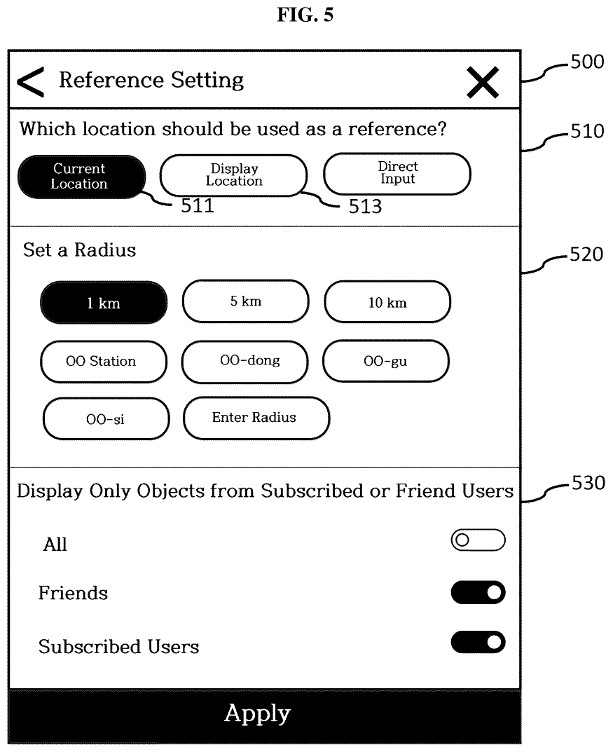

FIG. 4 schematically illustrates a screen in which the server 20 identifies location attribute information of an object according to one embodiment of the present disclosure.

FIG. 4(a) schematically illustrates a screen in which the server 20 generates location attribute information based on a plurality of place information included in an object 401.

FIG. 4(b) schematically illustrates a screen in which the server 20 generates location attribute information based on a name 420 of an object.

Referring to FIG. 4(a), the server 20 may generate location attribute information based on the plurality of place information included in the object 401. For example, when the plurality of places included in the object 401 are located within Pangyo Station Road 411, 413, and 415, the server 20 may generate location attribute information such as Pangyo-dong or Pangyo Station Road.

In contrast, the server 20 may generate a plurality of location attribute information. For example, when a plurality of places included in an object are located in Seongnam-si, Bundang-gu, and Pangyo Station Road, the server 20 may generate a plurality of location attribute information 431 such as Seongnam-si, Bundang-gu, and Pangyo Station Road.

Referring to FIG. 4(b), the server 20 may generate location attribute information based on a name 420 of an object 403. For example, when a name of an object is Pangyo Station Lunch Restaurant 420, the server 20 may generate location attribute information 433 such as Pangyo-dong or Pangyo Station Road.

In addition, an object may include tag information. Location attribute information may be an example of the tag information. Specifically, the server 20 may extract tag information of an object based on a name of the object, a name of a place within the object, and a review of the place within the object. For example, when a name of an object is Pangyo Station Lunch Restaurant, tag information included in the object may include information such as lunch and restaurant.

In addition, when a review of a place within an object includes content such as “This is a great place in Pangyo for group dining at lunch,” tag information included in the object may include information such as Pangyo, lunch, and group dining.

Hereinafter, with reference to FIGS. 5 to 8, an example of a method performed by the user terminal 10 for displaying an object including a plurality of place information will be described.

FIG. 5 illustrates a screen in which the user terminal 10 according to one embodiment of the present disclosure sets a reference for first location information through a reference setting interface 500.

Referring to FIG. 5, the reference setting interface 500 may include various interfaces. Specifically, the reference setting interface 500 may include a reference location selection interface 510, a radius setting interface 520, and an interface 530 for setting a predetermined relationship.

The user terminal 10 may set a reference for the first location information through the reference location selection interface 510. The reference location selection interface 510 may include an option for a current location 511 and an option for a location 513 selected by a user.

The user may select an option for either a current location 511 of the user or a location 513 displayed on a map interface. Alternatively, the user may directly enter a reference for the first location information to set a specific location as the reference.

The user terminal 10 may set a radius from the first location information through the radius setting interface 520. The radius may be set to a specific value such as 1 km, 5 km, or 10 km.

Alternatively, the radius may be determined based on a scale of a map. For example, as the scale increases, the radius may decrease, and as the scale decreases, the radius may increase.

Alternatively, the radius may be set based on a specific area such as OO Station, OO-dong, OO-gu, or OO-si. The specific area may be based on either a current location of the user terminal 10 or a location of the user terminal 10 displayed on the map interface. In addition, the specific area may be determined based on the scale of the map. For example, as the scale increases, the area may be set to a relatively large area range such as OO-si. However, as the scale decreases, the area may be set to a relatively small area range such as OO-dong.

In some cases, the user may determine the radius by directly inputting information related to the radius.

Through the interface 530 for setting a predetermined relationship, the user terminal 10 may be set to display only an object of a specific user that satisfies a predetermined relationship. For example, through the interface 530, the user terminal 10 may be set to display only an object shared by a user having a friend relationship or a subscription relationship.

Unlike what is illustrated in the drawing, the server 20 may receive a predetermined relationship from a specific user terminal that provides an object, rather than receiving the predetermined relationship through the interface 530 from the user terminal 10. Even in this case, the server 20 may provide the object only to users who satisfy the predetermined relationship.

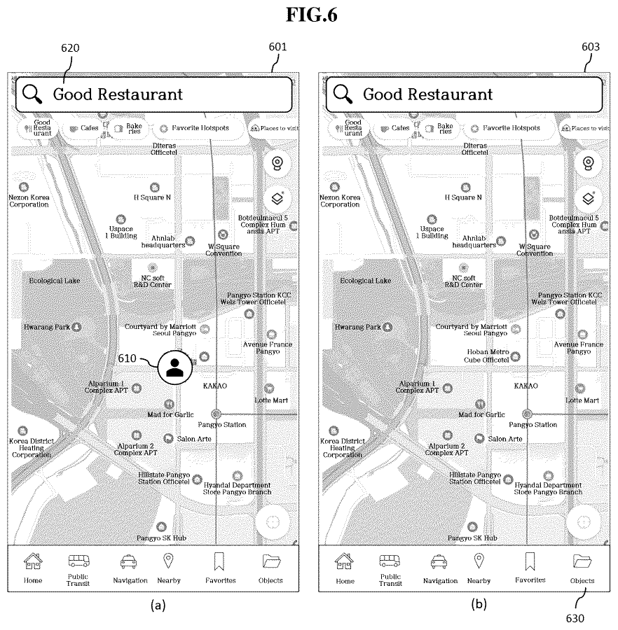

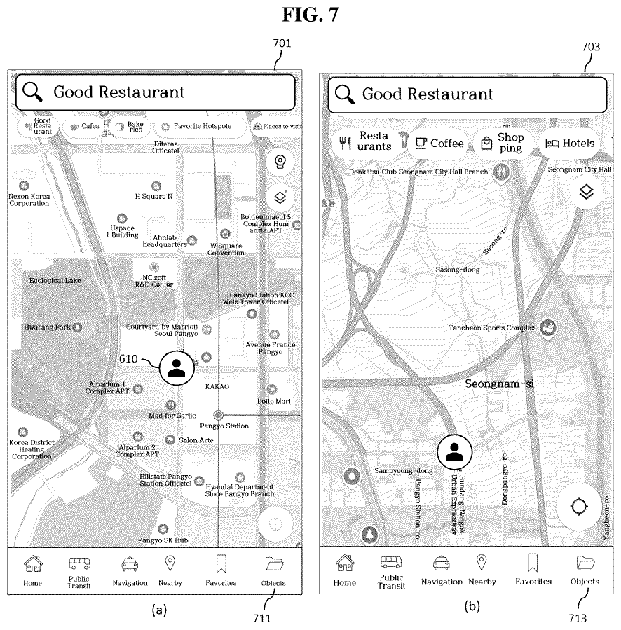

FIG. 6 illustrates a screen in which the user terminal 10 according to one embodiment of the present disclosure displays first location information on a map interface.

FIG. 6(a) illustrates a screen in which the user terminal 10 displays current location information 610 as first location information.

FIG. 6(b) illustrates a screen in which the user terminal 10 displays location information selected by a user as first location information.

Referring to FIG. 6(a), the user terminal 10 may display first location information on a map interface 601. As an example, the first location information may be a current location 610 of the user terminal 10.

The user terminal 10 may obtain an interaction related to displaying an object. As an example, the interaction may be receiving a query input through an input field 620. Specifically, the user terminal 10 may receive a query such as “Good Restaurant” from a user through the input field 620. In this case, the user terminal 10 may display an object including location attribute information related to the first location information, which is the current location information.

Referring to FIG. 6(b), the user terminal 10 may display first location information in a map service 603. As an example, the first location information may be location information selected by the user.

The user terminal 10 may obtain an interaction with an interface 630 configured to display an object. As an example, the interface configured to display an object may be displayed in a form of an object tab 630. The user terminal 10 may receive an interaction from a user with respect to the object tab 630. In this case, the user terminal 10 may display an object including location attribute information related to the first location information, which is location information selected by the user.

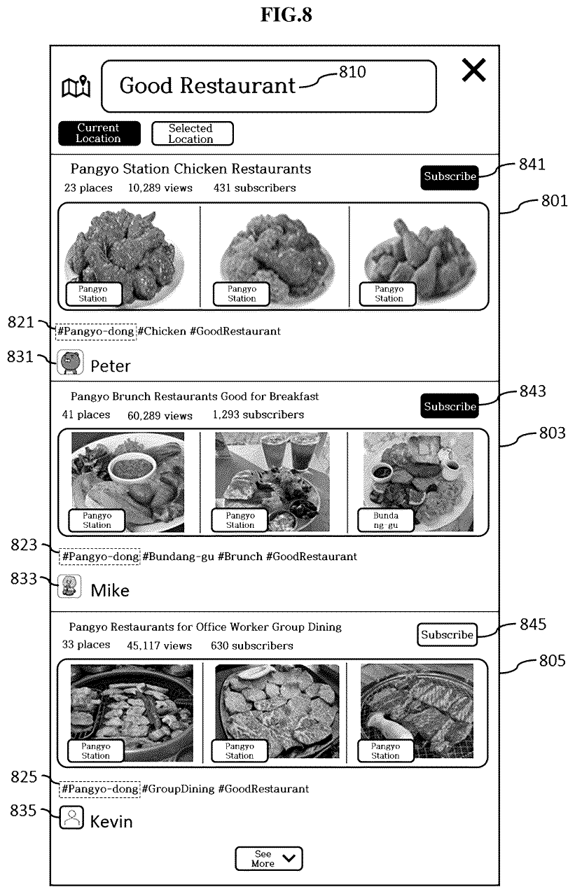

FIG. 7 illustrates a screen in which first location information is changed based on a map scale in the user terminal 10 according to one embodiment of the present disclosure.

FIG. 7(a) illustrates a map service in a state where a map scale is relatively small.

FIG. 7(b) illustrates a map service in a state where a map scale is relatively large.

Referring to FIG. 7, a location of the user terminal 10 may be the same in FIG. 7(a) and FIG. 7(b). However, in FIG. 7(a), since a scale of a map 701 is relatively small, the first location information may be determined to be Pangyo-dong. In this case, when the user terminal 10 obtains an interaction with an object tab 711, the user terminal 10 may display a plurality of objects including location attribute information such as Pangyo-dong.

However, in FIG. 7(b), since a scale of a map 703 is relatively larger than that of the map 701 in FIG. 7(a), the first location information may be determined to be Seongnam-si. In this case, when the user terminal 10 obtains an interaction with an object tab 713, the user terminal 10 may display a plurality of objects including location attribute information such as Seongnam-si.

FIG. 8 illustrates a screen in which the user terminal 10 according to one embodiment of the present disclosure displays an object including a plurality of place information.

Referring to FIG. 8, the user terminal 10 may display at least one object 801, 803, and 805. The at least one object 801, 803, and 805 may be an object that satisfies a predetermined condition.

For example, the first location information displayed in FIG. 6(a) and FIG. 6(b) may be Pangyo-dong. In this case, even if a user inputs a query that does not include location information, such as Good Restaurant 810, through an input field, the user terminal 10 may display an object including location attribute information such as Pangyo-dong. For example, the user terminal 10 may display objects 801, 803, and 805 including location attribute information such as Pangyo-dong 821, 823, and 825.

An object may include information on a user account that created the object. For example, a first object 801 may be created by Peter 831, a second object 803 may be created by Mike 833, and a third object 805 may be created by Kevin 835.

The user terminal 10 may display only an object that satisfies a predetermined relationship. For example, the user terminal 10 may display only an object having a subscription relationship. In some cases, as shown in FIG. 8, all objects including location attribute information such as “Pangyo-dong” may be displayed, and whether each of the objects is viewable may be determined based on a subscription status.

For example, since the first object 801 and the second object 803 are in a subscribed state 841 and 843, the user terminal 10 may be allowed to view the first object 801 and the second object 803. However, since the third object 805 is in an unsubscribed state 845, the user terminal 10 may be allowed to view the third object 805.

Unlike what is illustrated in the drawing, in some cases, an object that does not satisfy a predetermined relationship may not be displayed in response to an interaction related to displaying the object on the user terminal 10.

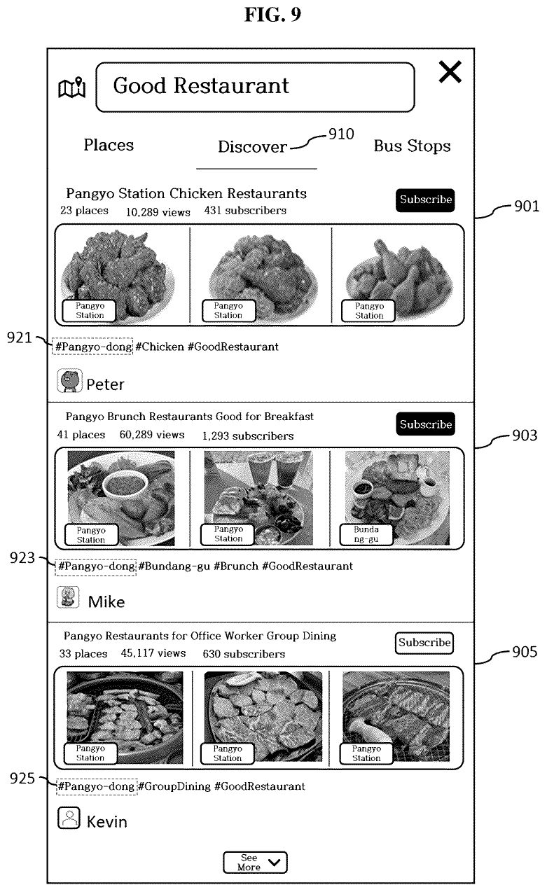

FIG. 9 illustrates a screen in which the user terminal 10 displays a plurality of objects 901, 903, and 905 in response to an interaction with an interface 910 configured to display an object.

Referring to FIG. 9, the user terminal 10 may display result information of a query, such as Good Restaurant. For example, the user terminal 10 may display a map service screen including information on a place related to the query.

The user terminal 10 may display a plurality of objects 901, 903, and 905 in response to an interaction with the interface 910. In this case, each of the object may be an object that satisfies a display condition. The display condition may be set such that the location attribute information includes the first location information. For example, when the first location information is Pangyo-dong, each object may include location attribute information such as Pangyo-dong 921, 923, and 925.

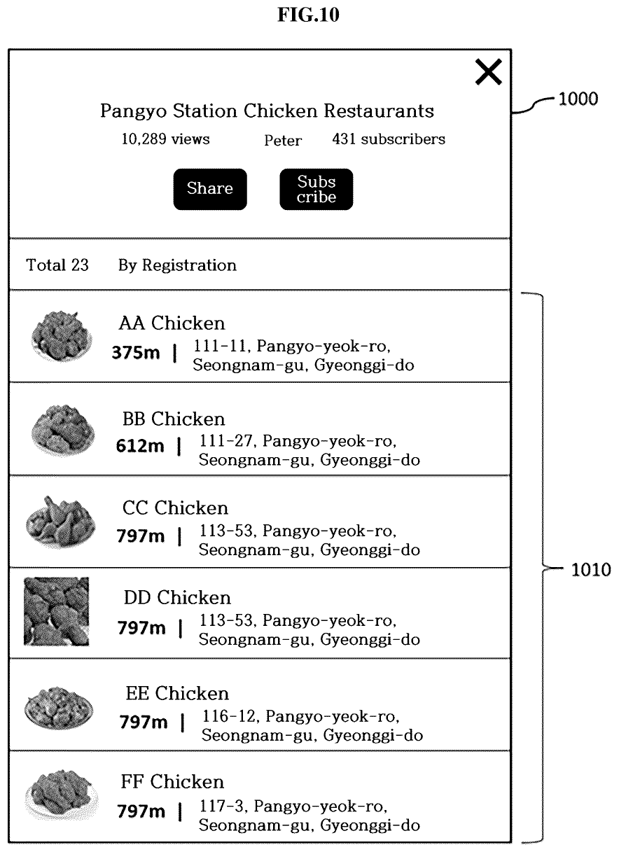

FIG. 10 illustrates a screen in which the user terminal 10 according to one embodiment of the present disclosure displays an object including a plurality of place information 1010.

Referring to FIG. 10, when the user terminal 10 obtains an interaction with a specific object 901 shown in FIG. 9, the user terminal 10 may display an object including a plurality of place information 1010. When the user terminal 10 obtains a selection interaction for any one of the plurality of place information 1010, the user terminal 10 may display, through a map service, information about a selected place.

In addition, the user terminal 10 may identify the plurality of place information 1010 included in the object and information on a user account that created the object, such as Peter, and may subscribe to the object 1000 or the corresponding user account.

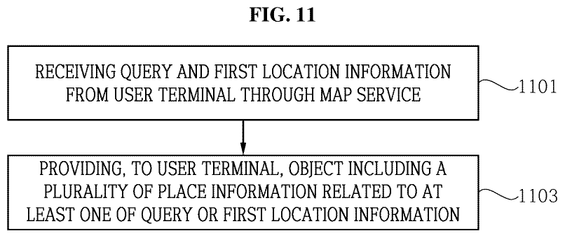

FIG. 11 is a flowchart illustrating a method performed by the server 20 for providing an object including a plurality of place information.

For convenience of description, descriptions of operations in FIG. 11 that are substantially the same as those in FIG. 2 will not be repeated, and reference is made to the description of FIG. 2.

In operation 1101, the server 20 receives a query and first location information from the user terminal 10 through a map service. Since operation 1101 is substantially the same as operations 201 and 203 of FIG. 2, a detailed description thereof will not be repeated.

In operation 1103, the server 20 provides, to user terminal 10, an object including a plurality of place information related to at least one of the query and the first location information. Since operation 1103 is substantially the same as operation 205 of FIG. 2, a detailed description thereof will not be repeated.

The present disclosure provides an advantage in that a user may share a plurality of places saved in a map service in the form of a single object, thereby enabling the saved places to be shared in a more flexible manner beyond personal use.

The present disclosure further provides an advantage in that each object includes location attribute information related to a location and includes places associated with a user's current location or a location indicated by the user in a map service.

The technical features disclosed in each embodiment of the present disclosure are not limited to the corresponding embodiment, and unless mutually incompatible, may be combined with technical features of other embodiments.

Accordingly, although each embodiment focuses on specific technical features, such features may be combined with one another as long as they are not mutually incompatible.

The present disclosure is not limited to the foregoing embodiments and the accompanying drawings, and various modifications and variations may be made by a person skilled in the art. Accordingly, the scope of the present disclosure should be defined by the claims and equivalents thereof.

What is claimed is:

1. A method performed by a user terminal for displaying an object comprising a plurality of place information in a map service, comprising:
displaying a map interface included in the map service and configured to display first location information;
transmitting a query related to the map service and the first location information to a server; and
displaying an object comprising a plurality of place information related to at least one of the query and the first location information,
wherein the object comprises location attribute information, and
wherein the location attribute information is determined based on the plurality of place information.

2. The method of claim 1, wherein displaying the object comprises displaying the object in response to an interaction with an interface configured to display the object.

3. The method of claim 1, wherein displaying the object comprises displaying the object together with result information of the query.

4. The method of claim 1, wherein the first location information is at least one of a current location information of the user terminal and location information selected by the user in the map interface.

5. The method of claim 1, further comprising:
displaying a reference setting interface for setting a reference for the first location information; and
receiving a reference for the first location information through the reference setting interface.

6. The method of claim 5, wherein:
the reference setting interface comprises information on an option related to the reference, and
the option comprises an option for a current location of the user terminal and an option for a location selected by the user.

7. The method of claim 1, wherein the first location information is determined based on a scale of the map service.

8. The method of claim 1, wherein the plurality of place information is a plurality of place information stored by a specific user account in the map service.

9. The method of claim 1, wherein the object is displayed only when search of the object is permitted by a user account that shares the object.

10. A method performed by a server for providing an object comprising a plurality of place information through a map service, comprising:
receiving a query and first location information from a user terminal through a map service; and
providing, to the user terminal, an object comprising a plurality of place information related to at least one of the query and the first location information,
wherein the object comprises location attribute information, and
wherein the location attribute information is determined based on the plurality of place information.

11. The method of claim 10, further comprising determining whether the query comprises second location information,
wherein, in providing the object,
the object comprises a plurality of place information related to the second location information when the query comprises the second location information, and
the object comprises a plurality of place information related to the first location information when the query does not comprise the second location information.

12. The method of claim 11, wherein the location attribute information is further determined based on at least one of the first location information and the second location information.

13. The method of claim 10, further comprising receiving information on the object from a specific user account.

14. The method of claim 13, wherein receiving information on the object comprises receiving the location attribute information of the object from the specific user account.

15. The method of claim 10, wherein providing the object comprises:
determining whether a predetermined relationship between a user account of the user terminal and the specific user account is satisfied; and
providing the object when the predetermined relationship is satisfied.

16. A server for providing an object comprising a plurality of place information through a map service, comprising:
a memory storing instructions; and
a processor configured to execute the instructions to:
receive a query and first location information from a user terminal through a map service; and
provide, to the user terminal, an object comprising a plurality of place information related to at least one of the query and the first location information,
wherein the object comprises location attribute information, and
wherein the location attribute information is determined based on the plurality of place information.
